(19) United States
(12) Patent Application Publication
(10) Pub. No.: US 2006/0191730 A1
(43) Pub. Date: Aug. 31, 2006

(54) Vehicular safety system including automated cruise control disengagement and warning signals

(76) Inventors: Ray M. Alden, Raleigh, NC (US); Richard S. Churilla, Cooper, FL (US)

Correspondence Address: Ray M. Alden, 808 Lake Brandon Travl, Ralugh, NC, 22610, US

(21) Appl. No.: 11/067,966

(22) Filed: Feb. 28, 2005

(51) Int. Cl. B60K 28/00; B60K 28/06; B60Q 1/00

(52) U.S. Cl. 180/272; 180/271; 340/438; 340/576

(57) ABSTRACT

The invention described herein represents a significant improvement in the safety of vehicles. The system monitors the driver's control of the steering of a vehicle. When the system senses that the vehicle's steering is not properly controlled, it disengages cruise control and can engage warning flashers, sounds audible on the vehicle's interior and exterior, brakes, and a warning transmission to be received electronically by a remote receiver for example in another vehicle. When control of the steering of the vehicle is regained by the driver, the system will again enable normal driver control of the vehicular systems that had been engaged or disengaged by the system

### BACKGROUND FIELD OF INVENTION

Modern vehicles including motorcycles, automobiles, trucks, boats, and aircraft employ many automated features to facilitate navigating and enhance safety. The present invention is an advancement that relates a driver's control of a vehicle to engagement and disengagement of vehicular systems to facilitate navigation and safety. A sensor is provided to sense when the driver ceases to be in proper control of the controlled vehicle and is used to automatically engage safety features to minimize danger to the driver and passengers in the controlled vehicle as well as minimizing danger posed to persons and property outside of the controlled vehicle.

### BACKGROUND—DESCRIPTION OF PRIOR INVENTION

The prior art describes automatic engine cut off under certain scenarios. One such system is commonly employed on hand-pushed lawnmowers whereby a lever is depressed when the mower is properly under the control of an operator. When the operator releases control of the hand held portion of the lawnmower, the lever is released thereupon causing a mechanical switch to engage an engine cut off and concomitant termination of blade rotation.

The prior art also includes automated touch control of electromechanical gymnastic equipment systems that are switched on when properly contacted by a user's hand and switched off when not properly in contact with a user's hand. Such systems employ a range of mechanisms to determine whether a user is in a safe position for operation including for example a predefined threshold of electronic resistance in a control circuit that is bridged when touched by a user or a predefined threshold of mechanical pressure applied by a user which is sensed and used to control a circuit.

Automated control of vehicle driving has long been envisioned and this field has now advanced to the point of enabling multiple vehicles to operate in close proximity of one another without any driver involvement in vehicle operation whatsoever. These systems often involve vehicles that operate in communication with one another and as such loose much of their effectiveness when deployed as individual vehicles as opposed to being deployed as a complete multi-vehicular system comprising many such vehicles. Thus these vehicles are not generally available to the public anywhere in the world and would be prohibitively expensive to deploy. The present system offers improved safety while also being available as an inexpensive aftermarket upgrade for existent vehicles or can be cheaply incorporated into current assembly lines to produce individual vehicles without the need for an expensive, complex, and radical overhaul of a nation's complete transportation system.

### BRIEF SUMMARY

The invention described herein represents a significant improvement in the safety of vehicles. The system monitors the driver's control of the steering of a vehicle. When the system senses that the vehicle's steering is not properly controlled, it disengages cruise control and can engage warning flashers, sounds audible on the vehicle's interior and exterior, brakes, and a warning transmission to be received electronically by a remote receiver for example in another vehicle. When control of the steering of the vehicle is regained by the driver, the system will again enable normal driver control of the vehicular systems that had been engaged or disengaged by the system.

### OBJECTS AND ADVANTAGES

Accordingly, several objects and advantages of the present invention are apparent. It is an object of the present invention to provide an automated safety system for a controlled vehicle. The system sensing whether the controlled vehicle's steering system is properly controlled. When the controlled vehicle's steering is not properly controlled, the system causes the vehicle to perform in a predetermined and safer manner. It is an advantage of the present system that the driver's control of the vehicle's steering wheel is sensed. It is an advantage of the present system that when the driver of the vehicle is not controlling the steering of the controlled vehicle, the cruise control is automatically disengaged as a means to prevent the vehicle from continuing uncontrolled at a high velocity. It is an advantage of the present system that when the driver of the vehicle is not controlling the steering of the controlled vehicle, the emergency flasher is engaged as a means to warn other drivers and pedestrians that danger is present. It is an advantage of the present system that when the driver of the vehicle is not controlling the steering of the controlled vehicle, its horn can be automatically engaged as a means to warn other drivers and pedestrians that danger is present and to potentially awaked the controlled vehicle's driver to the danger. It is an advantage of the present system that when the driver of the vehicle is not controlling the steering of the controlled vehicle, its brake system can be automatically engaged as a means to reduce the velocity of the controlled vehicle for the improved safety of the driver as well as other drivers and pedestrians. It is an advantage of the present system that when the driver of the vehicle is not controlling the steering of the controlled vehicle, the vehicle will transmit a warning signal that can be received by other vehicles and enable them to either automatically take action to avoid the improperly controlled vehicle or to alert their drivers that a vehicle which is not properly controlled is nearby so that those drives can avoid the vehicle.

It is an advantage of the present invention that a sensor is provided to detect whether a driver is properly holding the steering wheel of the controlled vehicle. It is an advantage of the present invention that the mechanism to detect whether the driver is holding the steering wheel is unobtrusive. It is an advantage of the present invention that the mechanism to detect whether the driver is holding the steering wheel can be embedded into the steering wheel. It is an advantage of the present invention that the mechanism to detect whether the driver is holding the steering wheel can be embedded into a cover that can easily be mounted on the steering wheel.

Further objects and advantages will become apparent from the enclosed figures and specifications.

### DRAWING FIGURES

FIG. 1a depicts a driver's hand completing the circuit of a relay control circuit with portions embedded within a controlled vehicle's steering wheel.

FIG. 1b depicts a controlled vehicle's steering wheel with relay control circuit contact points on the surface thereof.

FIG. 2 illustrates the circuit of a controlled vehicle in the properly operated mode.

FIG. 3 illustrates the circuit of a controlled vehicle in the improperly operated mode.

### DETAILED DESCRIPTION OF THE INVENTION

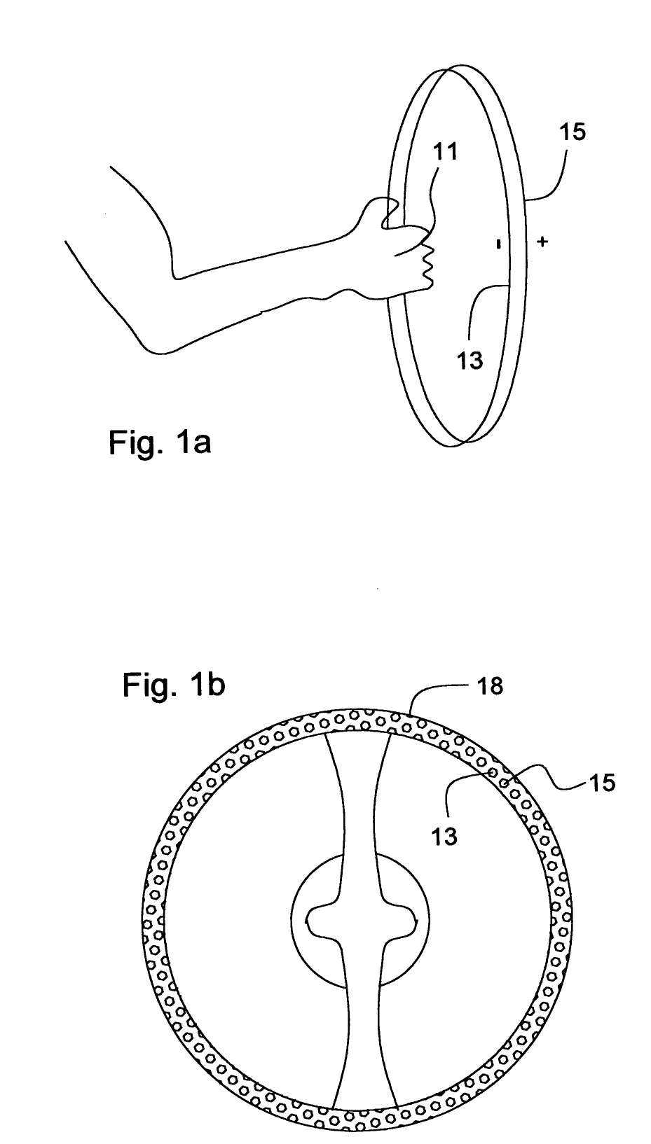

FIG. 1a depicts a driver's hand completing the circuit of a relay control circuit with portions embedded within a controlled vehicle's steering wheel. A controlled vehicle driver's hand 11 when holding onto the controlled vehicle's steering wheel causes the completion of a circuit comprising a negative side of a DC circuit 13 and a positive side of a DC circuit 15.

FIG. 1b depicts a controlled vehicle's steering wheel with relay control circuit contact points on the surface thereof. The circuit of FIG. 1a comprises an array of conductors that are arrange on the surface of a steering wheel 18 including a large number of conductors connected to the negative side of the circuit such as the 13 and the positive side of the circuit such as the 15. Current can not flow between the 13 and the 15 until a driver places her hand upon the steering wheel.

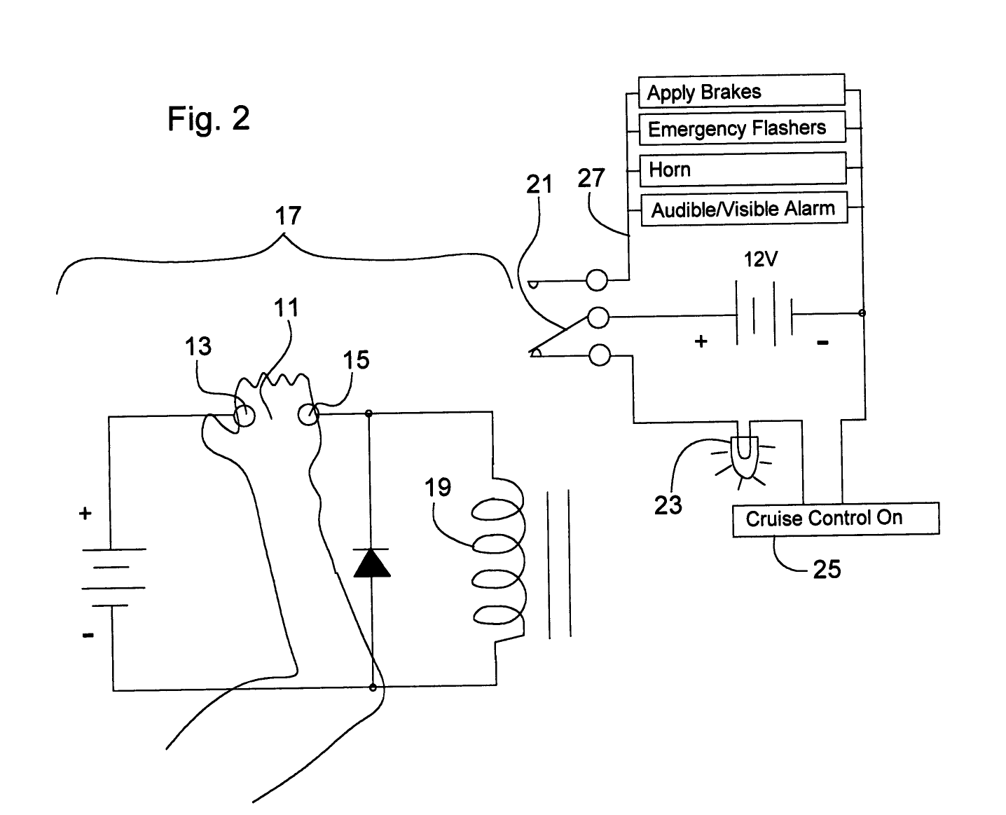

FIG. 2 illustrates the circuit of a controlled vehicle in the properly operated mode. As a properly positioned hand 11 grasps the steering wheel, it completes a circuit including the 13 and the 15 which in turn causes the relay circuit 17 and a coil therein 19 to switch a control switch 21 into a safe operation position which illuminates safe operating light 23 and enables the driver to engage the cruise control 25, meanwhile a disengaged side of a control circuit 27 is in the off position such that no automatic controls are automatically imposed upon vehicular systems.

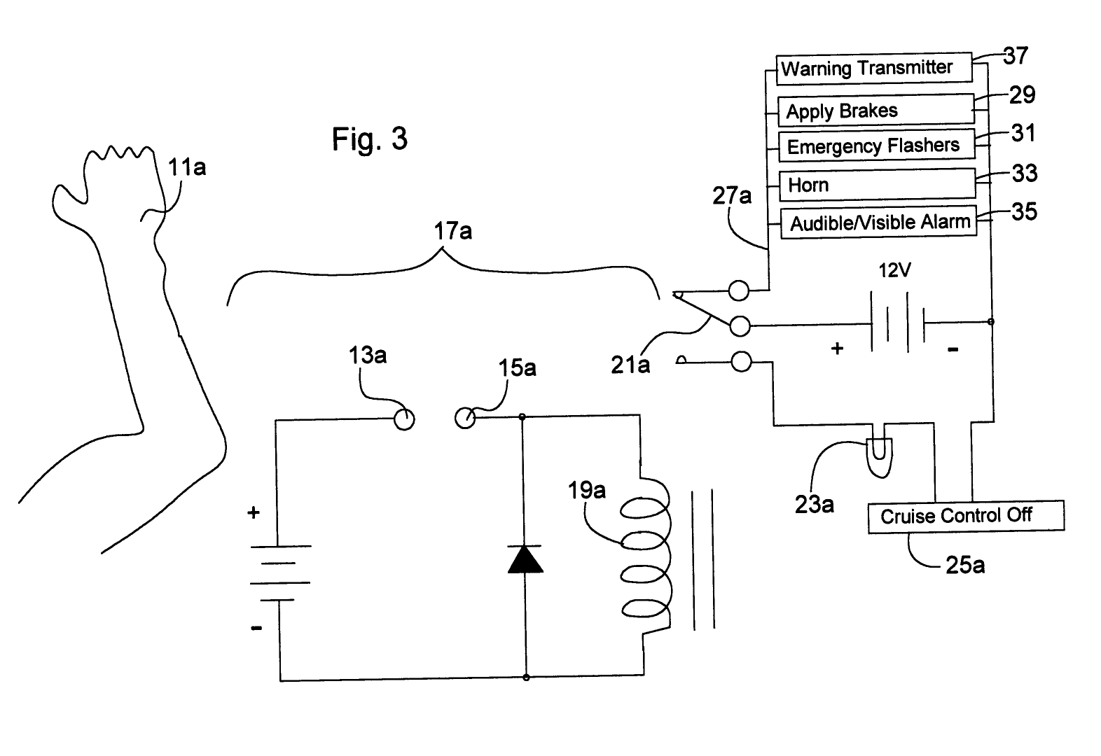

FIG. 3 illustrates the circuit of a controlled vehicle in the improperly operated mode. As an improperly position hand 11a is not in contact with the steering wheel, the circuit including the first incomplete circuit contact 13a and the second incomplete circuit contact 15a is not complete which in turn causes an incomplete relay circuit 17a and a non-active coil therein 19a to switch a control switch in second position 21a into an automated control operation position which enables automatic engagement of the vehicle's systems including an audible and visible alarm 35 within the vehicle which is energized to alert the driver that the vehicle is not properly under the driver's control, a vehicle horn 33 is activated to enable people external to the vehicle to be altered that the vehicle is not properly under control, a vehicle emergency flasher 31 is activated to enable people external to the vehicle to be altered that the vehicle is not properly under control, a brake 29 can be automatically applied to reduce the vehicle's speed, a broadcast warning 37 can be sent which can be sensed by receivers in other vehicles such that the other vehicle's automated control systems or drivers can take action to avoid the out of control vehicle. Also the cruise control will become automatically disengaged 25a as will the non-illuminated safe operating light 23a.

Those skilled in the art of electronics will recognize that circuits for each system such as horn, emergency flashers, cruise control, and a message transmission system can be easily connected to the art disclosed herein. The transmission message and frequency would have to be predetermined in coordination with a multiple vehicle system easily implemented by one skilled in the art. Electronic braking control systems which can be utilized herein are also known in the prior art.

This system can also incorporate means to disengage the automatic features of the system. For example, the system will only be operational when the vehicle is in motion. Likewise a switch can enable the driver to shut off the system as desired.

It is also anticipated that the driving habits of a drunk driver could be used to put the 21a into the override position to control the vehicle similarly to if a driver does not hold the steering wheel. The same can be said of a system for determining when a driver has fallen asleep. Such systems known in the prior art can be integrated with the art described herein to turn off cruise control and turn on emergency flashers, a beeping horn, and a transmission to alert other drivers.

### OPERATION OF THE INVENTION

Operation of the invention has been discussed under the above heading and is not repeated here to avoid redundancy.

### CONCLUSION, RAMIFICATIONS, AND SCOPE

Thus the reader will see that the Vehicular safety system including automated cruise control disengagement and warning signals of this invention provides an inexpensive, novel, unanticipated, highly functional and reliable means for enhancing the safe operation of a vehicle.

While the above description describes many specifications, these should not be construed as limitations on the scope of the invention, but rather as an exemplification of a preferred embodiment thereof. Many other variations are possible for example:

A means to sense whether the driver is holding the steering wheel on a controlled automobile is described herein. It will be recognized that other means to detect whether the driver is holding the steering wheel are possible. For example an infrared sensing camera in conjunction with a comparator can be used to calculate whether the driver is holding onto the steering wheel. Moreover, automated engagement of vehicular systems such as warning flashers, audible alarms, brakes, engine cut-off, electromagnetic message transmission, brakes, and automated steering can be initiated individually or corporately in response to other sensed stimulus such as drunk driving, sensing of the driver's eyes being closed, or lack of contact with the steering wheel. Similarly, automatic disengagement of automobile systems such as cruise control, a safe operating light, or a safe operating electromagnetic message transmission can be initiated individually or corporately in response to other sensed stimulus such as drunk driving, sensing of the driver's eyes being closed, or lack of contact with the steering wheel.

What is claimed:

1. A vehicle safety system for automatically controlling a vehicle, comprising:
a sensor for determining whether a driver is in control of the steering of a vehicle,
a circuit for controlling at least one element selected from the group consisting of; a cruise control disengagement, a safety light disengagement, a visible light emitter, an audible sound emitter, a braking control circuit, an engine cut off, and a warning signal transmitter,
wherein when said sensor senses that a driver is properly in control of the controlled vehicle said element is caused to be controlled by said driver and wherein when said sensor senses that a driver is not properly in control of the controlled vehicle said element is caused to be controlled by said circuit.
